(19) United States
(12) Patent Application Publication
(10) Pub. No.: US 2015/0215830 A1
(43) Pub. Date: Jul. 30, 2015

(54) Mobility with Discontinuous Reception Using Mobility State

(71) Applicant: NOKIA SOLUTIONS AND NETWORKS OY, Espoo (FI)

(72) Inventors: Lars Dalsgaard, Oulu (FI); Mikko Saily, Laukkoski (FI); Klaus Ingemann Pedersen, Aalborg (DK); Niko Sakari Kolehmainen, Espoo (FI)

(21) Appl. No.: 14/375,478

(22) PCT Filed: Jan. 30, 2012
(86) PCT No.: PCT/IB2012/050430

§ 371 Date: Sep. 5, 2014

(51) Int. Cl. H04W 36/00; H04W 8/08; H04W 76/04

(52) U.S. Cl. CPC H04W 36/0088; H04W 76/048; H04W 8/08; H04W 36/04

(57) ABSTRACT

The exemplary embodiments of the invention provide at least a method and an apparatus to perform operations including in response to an indication of a handover by a mobile device to another network cell, adjusting network measurement parameters from a first configuration to a second configuration based at least on a cell type of the another network cell, and performing measurements in the another network cell using the adjusted measurement parameters. In addition, the exemplary embodiments of the invention provide at least a method and apparatus to perform operations including determining, by a network node, an optimal measurement configuration to be used in another network cell based at least on a cell type of the another network cell, and sending information including an indication of the measurement configuration towards a mobile device.

### TECHNICAL FIELD

The teachings in accordance with the exemplary embodiments of this invention relate generally to improving mobility in a heterogeneous network and, more specifically, relate to improved mobility with discontinuous reception using mobility state in a heterogeneous network.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:

ACK acknowledgement
AP access point
AUC authentication center
BTS base station
CDF cumulative distribution function
DRX discontinuous reception
E-UTRAN evolved UMTS terrestrial radio access network
GSM global system for mobile communications
HARQ hybrid Adaptive Repeat and Request
HETNET heterogeneous network
HO hand over
ISD inter-site distance
ISD-R source cell radius
LTE Long term evolution
LTE-Advanced Long term evolution-Advanced
MAC media access control
MCC mobile country code
MCN mobile network code
MM mobility management
MNO mobile network operator
MSE mobility state estimation
PCF point coordination function
PDCCH physical downlink control channel
R source cell radius
RAT radio access technology
RRC radio resource control
RRM radio resource management
RSRP reference signal received power
RLF radio link failure
TTT time to trigger
UE user equipment or terminal
UMTS universal mobile telecommunications system
UTRAN UMTS terrestrial radio access network
3 GPP 3^{rd} generation partnership project

E-UTRAN mobility in an RRC connected mode introduces certain challenges as the mobility concept is based on connected mode mobility as it was defined in UTRAN. E-UTRAN mobility in RRC Connected mode only supports user equipment (UE) assisted network controlled mobility by use of hard handover. This means that mobility is based on the network configuring the UE with a given measurement configuration which the UE is then required to follow for the hard handover.

Adding a heterogeneous network (HetNet) to the mix adds to the mobility challenges, such as for a device in an E-UTRAN RRC Connected mode. One reason for this is that DRX impacts mobility measurement availability for event evaluation and has a severe impact as an allowed reaction time is shortened such that an outbound handover (HO) from a small cell, for example, can fail.

What is needed is a solution that can ensure that a HO to and from small cells, such as pico cells, in a HetNet environment can be performed in order to keep the mobility robust with minimum degradation in mobility performance and in a general manner without introducing too much complexity.

### SUMMARY

In an exemplary aspect of the invention, there is a method comprising in response to an indication of a handover by a mobile device to another network cell, adjusting network measurement parameters from a first configuration to a second configuration based at least on a cell type of the another network cell, and performing measurements in the another network cell using the adjusted measurement parameters.

In an exemplary aspect of the invention, there is an apparatus comprising at least one processor; and at least one memory including computer program code, where the at least one memory and the computer program code are configured, with the at least one processor, to cause the apparatus to at least, in response to an indication of a handover by a mobile device to another network cell, adjust network measurement parameters from a first configuration to a second configuration based at least on a cell type of the another network cell, and perform measurements in the another network cell using the adjusted measurement parameters.

In an exemplary aspect of the invention, there is an apparatus comprising means, in response to an indication of a handover by a mobile device to another network cell, for adjusting network measurement parameters from a first configuration to a second configuration based at least on a cell type of the another network cell, and means for performing measurements in the another network cell using the adjusted measurement parameters.

The exemplary aspect of the invention as described above, where the means for adjusting and the means for performing comprises an interface to a wireless communication network, and at least one memory embodying computer program code, the at least one computer program code executed by at least one processor.

In an exemplary aspect of the invention, there is a method comprising determining, by a network node, an optimal measurement configuration to be used in another network cell based at least on a cell type of the another network cell, and sending information comprising an indication of the measurement configuration towards a mobile device.

In still another exemplary aspect of the invention, there is an apparatus, comprising at least one processor, and at least one memory including computer program code, where the at least one memory and the computer program code are configured, with the at least one processor, to cause the apparatus to at least determine, with a network node, an optimal measurement configuration to be used in another network cell based at least on a cell type of the another network cell, and send information comprising an indication of the measurement configuration towards a mobile device.

In yet another exemplary aspect of the invention, there is an apparatus comprising means for determining, with a network node, an optimal measurement configuration to be used in another network cell based at least on a cell type of the another network cell, and means for sending information comprising an indication of the measurement configuration towards a mobile device.

The exemplary aspect of the invention as described above, where the means for determining and the means for sending comprises an interface to a wireless communication network; and at least one memory embodying computer program code, the at least one computer program code executed by at least one processor.

### BRIEF DESCRIPTION OF THE DRAWINGS

The foregoing and other aspects of embodiments of this invention are made more evident in the following Detailed Description, when read in conjunction with the attached Drawing Figures, wherein:

FIG. 1 is a type of bar graph indicating handover failure rate percentages for different DRX cycle lengths for each of a scaled down TTT and a default TTT;

FIG. 2 shows an A3 triggered activation of a short DRX cycle and/or increased measurement for a mobile device (e.g., UE) having an MSE indicating a trajectory or speed that is above normal, in accordance with the exemplary embodiments of the invention;

FIG. 3 shows a handover failure rate for different measurement intervals based on a long DRX of a mobile device (e.g., user equipment) that is moving at approximately 30 kmph;

FIG. 4 shows a handover failure rate for different measurement intervals based on a short DRX of a mobile device (e.g., user equipment) that is moving at approximately 30 kmph or having an above normal MSE;

FIG. 5A illustrates measurement points for different UE with the same DRX parameter but having different velocities/speeds and data flows, in accordance with the embodiments of the invention;

FIG. 5B shows increased measurement activity on a UE side after inbound handover, in accordance with the embodiments;

FIG. 6, is a simplified block diagram of various devices which are exemplary electronic devices suitable for use in practicing the exemplary embodiments of the invention; and

FIGS. 7A and 7B are logic flow diagrams that each illustrates the operation of a method, and a result of execution of computer program instructions embodied on a computer readable memory, in accordance with the exemplary embodiments of this invention.

### DETAILED DESCRIPTION

The invention is related to mobility in multi-layer cellular systems—also referred to as heterogeneous networks. In this context, multi-layer refers to cases where a mixture of macro base stations and small power base stations (e.g. pico and micro) are deployed as part of the same operator cellular network. More particularly, the invention relates to improved mobility with discontinuous reception using mobility state in a heterogeneous network.

It is noted that where the description uses multi-layer LTE networks in order to disclose the invention is non-limiting. The exemplary embodiments of the invention can be applied to other cellular networks, such as GSM and LTE networks, as well. Macro-layer and pico/micro layer may even be implemented in a different RAT (for example GSM macro layer and LTE micro layer). A pico cell/layer or micro cell/layer is typically covering a small area, such as in-building (offices, shopping malls, train stations, stock exchanges, etc.),

One important feature in E-UTRAN is the integrated support for enhanced UE power saving possibilities in RRC Connected mode using large discontinuous reception (DRX) cycles. The DRX, in LTE for example, describes the rules and requirements concerning how a UE shall monitor a PDCCH for potential UL/DL grants for the UE. In other words, the UE is not required to monitor the PDCCH at all times if a DRX is configured. The UE may, during a given sub-frames where the UE is not required to monitor the PDCCH, go into power saving mode. As uplink is scheduled in a downlink PDCCH, DRX parameters impact mobility and both uplink and downlink performance for all UEs. More particularly, the DRX allows the UE and the network negotiate phases in which data transfer occurs. During other times the device turns its receiver off and enters a low power state.

The DRX is usually a function designed into the protocol that allows this to happen and also. Further, the DRX can be used to identify how a transmission is structured in slots with headers containing address details. These details so that devices can listen to these headers in each slot to decide whether the transmission is relevant to them or not. In this case, the receiver only has to be active at the beginning of each slot to receive the header, thus conserving battery life.

In an RRC connected mode, for example, a UE sends measurement reports to network according to given configured events. Network may then use the received measurement reports for initiating mobility, such as to stronger neighbour cells and/or to minimize interference. In the RRC connected mode the UE can be configured with a UE specific DRX and mobility is controlled by the network using handovers.

In an RRC idle mode, the UE acts more autonomously, but still under guidance from network configuration and defined and specified behaviour, and UE measurements for mobility are used by UE to rank the cells. This ranking can be done with a cell reselection process guided by network settings and specified UE behaviour. In idle mode the DRX is provided in the UE's paging period. The DRX is configured for the UE by the network, but in the RRC idle mode mobility is controlled by the UE.

Use of DRX in RRC Connected mode is seen one of the keys to enable efficient power savings on UE side when UEs are more always online and therefore continuously in RRC Connected mode. In the future the amount of devices (it may be UEs, smart phones, smart devices or any other wireless connected device) that are always online is foreseen to increase dramatically and therefore there is a need to ensure that also devices that applies DRX in connected can still support robust mobility independently from the configured and applied DRX—which is currently done using UE assisted network controlled handover.

The long DRX cycles while a UE is in connected mode are similar in length to idle state DRX cycles. Measurements are reported by the UE to the network for handover decision making. Connected mode power savings through usage of long DRX allows less frequent measurement sample requirements for the UE. This enables full advantage of the power saving options (i.e. UE is allowed to take mobility measurement related samples at longer intervals with DRX ON compared to continuous reception with DRX OFF). This approach means that even in macro layout, care has to be taken by network side in order to ensure that the network configures the UE with mobility related parameters that are suitable for applied DRX configuration.

It is noted that a problem can occur when a UE is moving, such as moving faster than walking speeds. This is due to a long DRX combined with UE measurement points as in the prior art. Especially in a small network, this can introduce multiple problems including low measurement accuracy, little reaction time, and the event triggering is longer due to filtering, etc.

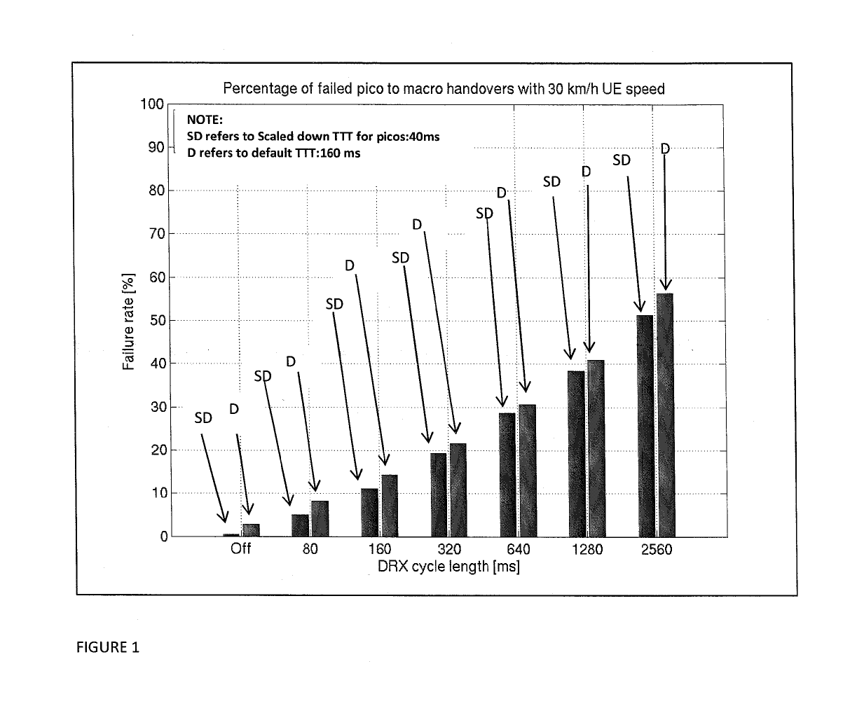

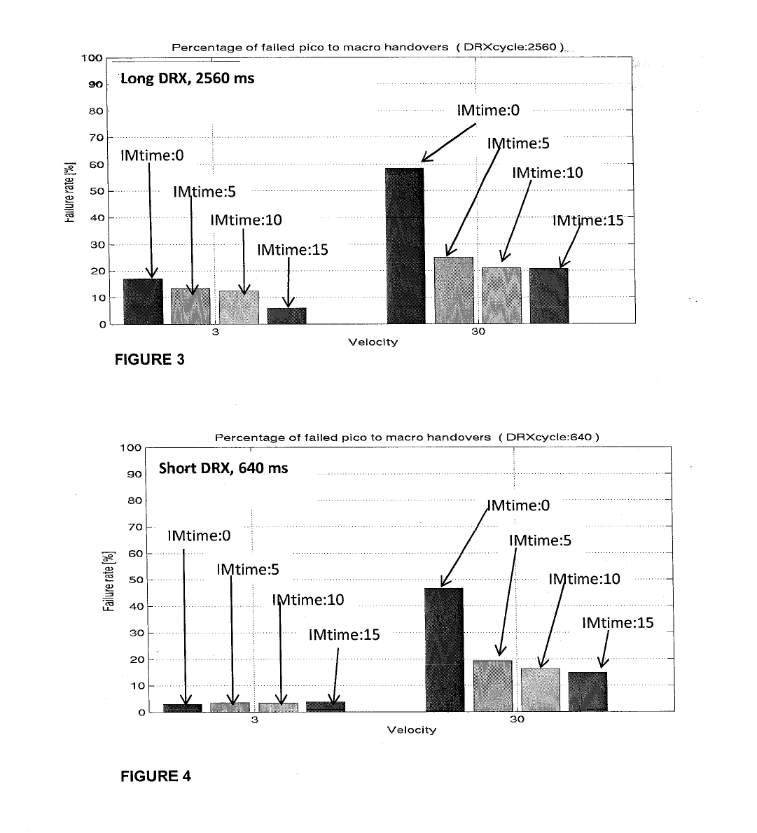

In addition, a heterogeneous network (HetNet) introduces challenges to mobility, such as in an E-UTRAN RRC Connected mode. One reason for this is that a DRX can impact mobility measurement availability for event evaluation such that a reaction time by devices for outbound handover (HO), such as from small cells, is rather short. For example, a problem can occur in a HetNet environment when a UE is moving at a higher velocity (e.g., 30 km/h or more) and has a long DRX (e.g., 640 ms and above). In this scenario the reaction time using existing standardized methods for triggering an outbound HO in a pico cell, for example, is too slow. This is for the reason that during the time between when a handover (e.g. an event A3) is triggered and when the HO signaling starts/finalizes the UE has moved such that the signal with the serving cell becomes weak. In this situation, the HO signaling can be weak or unsuccessful and, thus, lead to radio link failure. Our simulations have shown that such a problem is exemplified as a result of late triggering of an event and/or a handover failure due to a long DRX and small cell characteristics (see FIGS. 1 and 3 for example).

In heterogeneous network scenario the challenges of using long DRX are obvious and many times the UE specific DRX configuration is not able to solve the mobility problems. Reason for this is the DRX cycle length and its impact on the availability of mobility measurements for evaluating the handover events. According to current 3GPP standards, for example, UE perform measurements as instructed and the UE send measurement reports to a network according to configured events. The network may then use the received measurement reports for initiating mobility based on the received measurement report, such as to a stronger neighbor cell.

For example, it has been proposed in the submission R2-113794 presented at the 3GPP TSG-RAN WG2 Meeting #75 in Athens Greece on 26 Aug. 2011 that for an outbound pico-macro handover, problems increase as a velocity of the UE increases. It has been decided that a long DRX cycle during the outbound handover from a small power cell will cause mobility problems.

Further, the submission R2-115731, the source Nokia & NSN, presented at the 3GPP TSG-RAN WG2 Meeting #75bis in Zhuhai China on 10-14 Oct. 2011 demonstrates mobility problems related to long DRX and problems are identified especially at UE velocities above pedestrian mobility profile (e.g. more than 3 km/h). Simulation results show the impact on handover failure rate and UE power consumption in connection with different DRX values and UE velocities. Even with optimized mobility and DRX parameters there are still challenges in mobility robustness in different scenarios as well as a negative impact on the experienced UE power consumption.

The above mentioned problems are also a challenge in homogeneous macro layer/cell network when using long DRX cycles. Usage of long DRX means that the macro layer/cell network has to ensure that the network configures the UE with mobility related parameters that are suitable for the applied long DRX configuration. In addition, “diverse data applications” running on UE are vulnerable to problems associated with long DRX cycles. For example, applications which require frequent keep-alive type messages and/or are “always on” can be adversely effected at higher UE velocities and long DRX cycles, at least for the reason that the signaling for these features can be lost due to a long DRX cycle. Basically, “diverse data applications,” refers to single or multiple applications running in parallel on a UE or terminal.

### Further Disadvantages of the Prior-Art

1. Current 3GPP specifications and DRX related parameters don't have an option to enable UE velocity dependent configurations.
2. It can be seen from FIG. 1, discussed below, that scaling “only” the TTT to enable shorter intervals to trigger measurement reporting will only a small difference which is not seen to solve the mobility problem in HetNet.
3. Measurement requirements and related parameters as currently specified in 3GPP are not supporting heterogeneous network deployments. This means that a new DRX configuration would need to be signaled to UE at every handover in order to support mobility between large coverage cells and small power cells. Furthermore, these configurations would need to take into account both serving cell type and prevailing velocity of UE. When a fast moving UE is travelling through a dense small power cell deployment area, e.g. a pico cluster, a large number of reconfigurations is needed.
4. Current Mobility State Estimation has been mainly designed for macro deployment purposes and when Mobility State Estimation (MSE) is applied during connected mode, only the TTT parameter will be scaled, which is not solving mobility problems. Furthermore, based on present standards the MSE can emphasize the mobility problems identified in mixed deployment with macro and small power base stations and as a result the medium and fast moving UEs will enter small power cells even faster.

From the prior art it can be analyzed that if a handover is not performed into a small power cell, the UE will experience very high interference from the small power cell which in turn may lead to various unwanted side effects such as radio link failure, loss of service, UE cannot be paged or is not reachable in general etc. It should be also noted that there is a connection between DRX and mobility problems, and it is evident from the description that for example a long DRX during the outbound handover from a small power cell will cause mobility problems almost regardless of shortening the TTT value.

In order to address at least the problems, as discussed above, caused by a UE moving at a given velocity while at the same time having DRX applied, in accordance with the exemplary embodiments, there is at least a method to enable:
a network to configure a UE to perform additionally measurements for a given time limited period after inbound handover;
the configuration can set a measurement period depending on a cell type (femto, pico cells etc.) and taking into account an estimated cell coverage.
using the estimated cell coverage and a given maximum velocity of the UE to determine optimal mobility parameters and/or measurement periods for the UE works; and
configure the UE to perform additional measurement after an inbound handover, for example such behavior is configured in the cell.

In accordance with the exemplary embodiments there is presented a solution where indicated mobility robustness problems related to discontinuous reception (DRX) are solved by providing a UE(s) with a configuration consisting of DRX rules associated with UE velocity and serving cell type characteristics. When entering a cell each UE or network shall use this information in configuring the DRX behavior while considering its estimated mobility state together with serving cell type characteristics.

In regards to FIG. 1, as mentioned above, there are shown handover failure rate percentages for different DRX cycle lengths for each of a scaled down TTT and a default TTT. It can be seen that the length of the DRX makes a substantial difference whereas, as similarly stated above, the scaled down TTT at each of the DRX cycles lengths provides only a small benefit.

In accordance with the embodiments of the invention, a UE that is moving at velocity above stationary (e.g. normal pedestrian or vehicle mobility) is configured to perform additional mobility measurements for a restricted period of time after entering a small power cell. The configuration can be applied by a network to due to a shorter DRX periodicity required for the network, for example. Alternatively, measurements at shorter intervals can be performed independently from the currently applied DRX and/or a currently applied DRX value can be scaled to a shorter value by a factor according to an estimated mobility state of a UE. In accordance with the exemplary embodiments, a measurement interval, as well as the time period or window during which measurements are performed, is configured based on a cell size and mobility state of UE. Further, in accordance with the embodiments, the applied configuration can be UE specific or broadcasted to all UEs by the network.

For example, in accordance with the embodiments, if a UE is moving and enters a cell, such as a small cell, short DRX cycles can be configured at the UE. In accordance with the exemplary embodiments, a determination of whether the UE is moving can use a mobility threshold setting which can be predetermined for the UE and/or configured at the UE, such as based on configuration information from the network, or determined by the UE and/or the network. In the case of a handover, a mobility state, and optionally a hysteresis, of a UE can be determined by the UE and reported to a network, and/or can be determined by either a source network and/or a destination network. Such determinations can be used to implement measurement configurations, in accordance with the embodiments, at a UE. Further, in accordance with the exemplary embodiments, if it is determined that the UE is no longer moving or is moving more slowly, such as based on the above stated operations, moving, the UE is can may be configured to revert back to its previous mobility state and/or longer DRX.

The exemplary embodiments of the invention, enables robust outbound mobility for pico-macro handovers for fast moving UEs while slow moving (or stationary) UEs will revert to and/or continue to use a usual or longer length DRX. For example, if a faster moving UE enters a small cell and becomes stationary shortly after entering the cell, a mobility state estimate for the UE will change in response to the UE becoming stationary and the UE then can perform measurements using a changed, or longer, DRX cycle.

Operations in accordance with the exemplary embodiments of the invention include at least:
After inbound handover
   The UE will update a MSE formula based on, but not limited to, any current or adopted MSE related method.
   The Network will update the estimated mobility state of the UE, such as based on the above described determinations and/or available history information, when UE is in an RRC connected state or an RRC idle state. Historical information can include, but is not limited to information related to cell changes by the UE over the time and/or determinative algorithms.
   Information related to a determined or estimated mobility state may be exchanged between the UE and a network using signaling, and/or estimated independently by either the UE or the network. In accordance with the embodiments, estimates made by the UE and/or the network may be used for measurement configuration at the UE.
If the estimate(s)/determination(s) is that a mobility state of UE is that the UE is moving or moving faster, such as above a configured velocity threshold, and an MSE and/or serving cell characteristics indicate a small power cell and/or a priority cell, the UE is configured to use a short or shorter DRX. In such a case, the UE can be configured to perform measurements at intervals will decrease or remain shorter, such as for a given time and/or as long as a determined mobility state of the UE indicates that the UE is moving and is not stationary, or is moving at a velocity which exceed a velocity threshold configured for the UE. Further, the UE may be configured to use a short or shorter DRX only after it is determined that the UE is moving, or is moving at a velocity which exceed a velocity threshold, for at least a set period of time. This set period of time can be provided to the UE by the network or configured by the UE.
If/when UE is not moving above a predetermined or configured velocity threshold, such as at pedestrian velocities, the mobility state returns to, or remains at a ‘normal’ and/or usual and/or initial mobility state for the UE. Further, in this case UE measurement intervals will increase, or revert back to a less frequent measurement interval. In addition, in accordance with the exemplary embodiments, measurement intervals and/or a DRX which is in use, but not needed, may be reverted back to a longer and/or an original DRX/measurement interval and/or mobility state of the UE. UE can cause this reverting back autonomously or the network can cause the UE to revert back, such as by providing new measurement configuration instructions to the UE.
The estimates of the mobility state, as described above, can also be performed by the network and the UE using S1/X2 information elements, such as via an S1/X2 interface, to communicate historical information. This historical information can include, but is not limited to, information related to a list of last visited cells, cell types and characteristics, and a time spent in each cell. Therefore, the network can predict the UE mobility profile. This is true even if a number of handover events of an UE are not enough to classify a mobility state of the UE as above normal. In accordance with the embodiments, the network can estimate the average mobility characteristics and proactively enable shorter DRX cycle for an UE even before a measurement reports is triggered indicating a need for a handover to a small cell.
Network can also proactively configure the UE with DRX parameters suitable for the estimated UE mobility state. This proactive configuration can be based on the available history information as at least described above. Using such information the network can estimate, such as based on a threshold as described above, that the UE mobility state has changed and the network can reconfigure the UEs DRX parameters accordingly. This method is possible in connected mode while support of this for idle mode is also possible.
Alternatively, in accordance with another embodiment of the invention, to modifying the DRX cycle frequency of mobility measurements can be altered depending on the MSE and a current serving cell type. This means that when a determined MSE is above normal, the UE is forced or required to perform increased mobility measurements even during the enabled DRX state. If measurements trigger a reporting event, the UE will send a scheduling request to the network in its allocated transmit time interval. Advantage of this alternative embodiment is that while mobility robustness is improved, there will be some UE battery power savings when UE performs increased RRM measurements but doesn't have to monitor PDCCH.
A DRX cycle or measurement interval can be scaled and/or configured, as described above, based on an estimated mobility state for both RRC_connected state UE and RRC_idle state UE.

Where a UE has mobility state which identifies movement and the serving cell is a small power cell, the DRX period or measurement periodicity can be decremented by an UE specific signalled factor, decremented by a factor dependent on the mobility state, or switched to a preconfigured shorter DRX period or a scaling factor signalled in system information blocks. When UE is estimated to fall back to the normal mobility state, UE can increase the DRX length to a larger value automatically. This can be done step-wise to the next larger value, or directly back to the original longer DRX value.

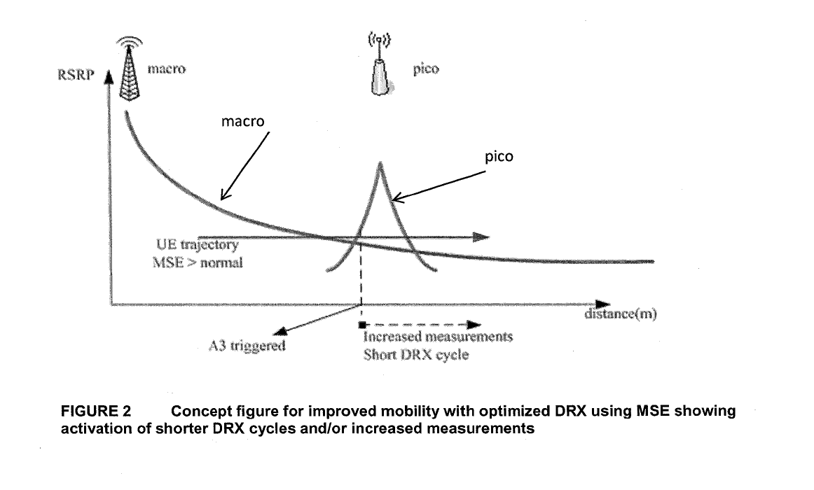

With regards to FIG. 2, there is shown a UE that has an MSE indicating a trajectory or speed that is above normal and a trajectory from a macro cell towards a pico cell. As illustrated in FIG. 2, when the UE enters the pico cell an event is triggered, such as with A3 event. The triggered event causes at least an activation of a short DRX cycle and/or increased measurement for the UE, as in accordance with the exemplary embodiments of the invention.

In accordance with the exemplary embodiments, a basic behaviour or operation can be defined in multiple ways. Some examples include:
1. Network broadcasts information about the cell size or type (femto, pico etc.). When UE enters a cell of e.g. femto type it will/shall perform additional measurement potentially according to shorter DRX cycle for a given time when mobility state is above normal.
   a. Time for which to apply the additional measurements would depend on the mobility state, and optionally also on the serving cell size. The period could be defined directly in specification (e.g. 36.133), it could be broadcasted, signalled to UE, or UE could calculate it based on some cell size or type information.
   b. A scaling factor can be used to scale the default DRX cycle to a shorter value, e.g. in a similar manner compared to Mobility State Estimation and related scaling factors [0.25, 0.50, 0.75, 1.00] defined in 36.304 and 36.331.
2. Network configures the UE to perform the specified behaviour e.g. by using the measurement configuration. This could be done in two ways:
   a. New fields are included in the measurement configuration indicating the measurement interval as well as the time period
   b. Include a new indicator in the measurement configuration or in speed related parameters which informs the UE to apply this behaviour in the cell.
3. UE will always after inbound handover, depending on the mobility state, perform additional measurements for a given time period with a given time periodicity.
   a. Time period and periodicity could be network configured
   b. Time period and periodicity could be defined in specification
   c. Time period and periodicity could be UE implementation

With regards to the new fields and new indicators, as discussed above, these can be used to determine and/or signal a measurement configuration, such as with system information blocks, indications/identifiers regarding mobility states and/or cells. These indications/identifiers can be used to determine and/or provide the novel measurement configuration, as implemented by UE. In accordance with the exemplary embodiments, indications/identifiers can include, but are not limited to:
“Above normal” mobility profile indicator or mobility state indicator can indicate, for example, that a movement or velocity is greater than a specific speed (e.g., 3 km/h, 30 km/h).
A mobility state estimate indicator can be used to indicate whether the movement or velocity is normal, above normal medium, high, etc.
A mobility profile indicator can be used to identify whether UE, for example, is for use in, though not limited to, vehicles, airplanes, etc., such that the mobility profile of the UE is other than stationary and/at pedestrian speeds.
A small and/or low power cell type indicator can identify, for example, a source or destination cell type, for example a micro, pico, femto cell type;
A cell size indicator, for example, using an enumerated value to indicate medium, small, very small, etc.;
A cell size indicator using, for example, a numerical absolute value, for example 1800m, 200m, etc.;
A cell weight indicator using, for example, a numerical relative value, for example 1.0, 0.5, 0.25, etc.; and
A priority cell indicator, which indicates whether a cell, such as a small and/low power cell, has high or higher importance for network coverage and/or whether or not a cell is a cell with a capacity that is preferred for fast moving UEs. For example, a priority cell indicator can identify a small and/or low power cell that fills a coverage hole in macro deployment. A priority cell can be indicated in system information blocks as a specific priority cell type, for example.

Based on initial network simulations it has been shown that increased measurements can be used to improve mobility robustness significantly while having a minimal increase to UE power consumption. In addition, a DRX cycle needs to be configured according to a serving cell type (e.g. macro vs. pico) and according to mobility profile of an UE (e.g. stationary, pedestrian, vehicle).

As an example, consider a case where a cell coverage area is estimated to be 100 m, and UE defined HO and/or DRX parameters are sufficient to enable robust handover at a mobility of up to 30 km/h. In this case, the network provides indicators that instruct the UE to perform additional measurements, for example every 12 seconds, in the cell after an inbound HO. It is noted that these operations can be deployment dependent and, generally, small cells are deployed in areas where a high velocity, such as 120 km/h, is unlikely. By combining the cell type (known on network side) and a potential UE movement scenario it can be estimated what would be the worst case ‘travel through’ time for the cell (e.g., (worst case cell diameter/((30 km/h)/3.6)), e.g. 100 m/8.3=12 seconds). After inbound handover to a small cell, a short DRX cycle can be triggered for a fast moving UE which allows for shorter measurement intervals within the regular DRX cycle. This allows additional scheduling of resources to facilitate the best power saving and QoS trade-off for the given UE.

It is noted that if mobility parameters are not considered for all kinds of mobility profiles, then it is possible that late handovers may become a problem. SON (Self Organizing Network) algorithms can minimize problems related to late handovers. However, at network side the parameters can be optimized either for slow or fast moving UEs (but not for both!) using SON algorithms. Therefore, DRX cycle optimization at UE side can provide additional degree of freedom in optimizing the mobility performance and providing the mobility robustness.

The exemplary embodiments of the invention are also relevant to the work item RP-111372 “LTE RAN Enhancements for Diverse Data Applications” proposed at the 3GPP TSG RAN Meeting #53 in Fukuoka, JAPAN on 13-16 Sep. 2011 when considering long DRX cycle periods in HetNet. In this work item it is stated that “Enhancements to DRX configuration/control mechanisms to be more responsive to the needs and activity of either single or multiple applications running in parallel, with improved adaptability to time-varying traffic profiles and to application requirements, thereby allowing for an improved optimisation of the trade-off between performance and UE-battery-consumption.” In this working item there may be similar type of problems and DRX based solutions seem to be identified as potential solutions. For diverse data applications similar mobility related optimizations can be used, but in this case DRX shall be configured also in conjunction with the application requirements. For example, an UE may have an active “Diverse Data Application” running and mobility state is above normal (estimated by the network based on history information. Such information obtained using an S1/X2 interface, or estimated by the UE and reported to network, for example. Therefore, in accordance with the embodiments, the UE can use a DRX cycle optimized to HetNet considering different cell types and mobility state.

The exemplary embodiments of the invention provide at least a method which can be implemented and optimized together with radio resource scheduler and HARQ. The exemplary embodiments provide that a network can know the activity requirements for an application of an UE. This can be the basis for the normal or long DRX period. When mobility state of an UE at network goes above normal, the HARQ retransmissions can be still planned outside of the predefined DRX cycle to allow for tighter measurement intervals and DRX optimization.

The decreased UE sleep time with shorter DRX cycle was shown to have minimal impact to power consumption. At the same time new scheduling opportunities are created within the current DRX cycle when an UE with above normal mobility state is scheduled with the shorter DRX cycles.

A “smaller than macro” cell can fill a coverage hole between two macro cells. Therefore it is not always possible to avoid connecting fast moving UEs to small power cells. DRX cycle optimization will enable small cells also for fast moving UEs without a need to configure those UE using short DRX cycles everywhere, thus having excess power consumption. Freedom of using short DRX cycles more often due to lower impact to power consumption will reduce the risk of radio link failures

Black listing small power cells for fast moving UEs may be problematic in intra-frequency deployment. The proposed method can be used to complement grey lists (e.g., conditional black lists) and it is possible to offer more robust outbound handovers out from grey listed small power cells. That is, in accordance with the exemplary embodiments of the invention, when a non-stationary UE enters a grey listed small power cell due to interference (condition using a grey list fulfilled) a short DRX cycle shall be enabled.

As an example, consider a case where a cell coverage area is estimated to be 100 m, and UE defined HO and/or DRX parameters are sufficient to enable robust handover at a mobility of up to 30 km/h. In this case, the network provides indicators that instruct the UE to perform additional measurements, for example every 12 seconds, in the cell after an inbound HO. It is noted that these operations can be deployment dependent and, generally, small cells are deployed in areas where a high velocity, such as 120 km/h, is unlikely. By combining the cell type (known on network side) and a potential UE movement scenario it can be estimated what would be the worst case ‘travel through’ time for the cell (e.g., (worst case cell diameter/((30 km/h)/3.6)), e.g. 100 m/8.3=12 seconds). After inbound handover to a small cell, a short DRX cycle can be triggered for a fast moving UE which allows for shorter measurement intervals within the regular DRX cycle. This allows additional scheduling of resources to facilitate the best power saving and QoS trade-off for the given UE.

In accordance with the exemplary embodiments of the invention there is method including:
An indication of a cell type provided by the network (e.g., femto, pico etc.). Such that when a UE enters a cell, for example a femto type cell, the UE will perform additional measurement(s) for a given time;
Time for which to apply the additional measurements would depend on cell type. The period could be predetermined or the UE could calculate it if some defined cell coverage is given to UE; and
The network configuring the UE to perform specified operations, such as with a provided measurement configuration.

The exemplary embodiments of the invention provide at least a method where:
new field(s) are included in the measurement configuration indicating the measurement interval as well as the time period;
a new indicator is included in the measurement configuration which informs the UE to apply this behavior in the cell;
a UE is configured to perform additional measurements for a given time period with a given time periodicity after inbound HO; and
network configured time period(s) and/or periodicity for measurements can be included in the measurement configuration, measurement time period(s) and/or periodicity could be pre-defined for the UE; and/or measurement time period(s) and/or periodicity could be determined and/or implemented by the UE.

In accordance with the exemplary embodiments of the invention, there is enabled a novel functionality where the UE will perform additional measurements for a period of time after inbound HO (entering) to a small cell. These additional measurements will be performed for limited time period which would equal the time it would take a UE to cross the cell at a given velocity which again is determined by the limits given by the mobility parameters in terms of ensuring robust mobility support:

If the UE is moving at or at higher velocity than the velocity limit used for calculating the time period during which additional measurements shall be performed (which is again determined by the limit at which robust mobility can be ensured using the given mobility and DRX parameters), this will remove the problem introduced by having the combined effect from high velocity UE in small cell applying DRX. Reason being that the UE will perform increased/additional measurements during the time it is in/served by the small cell coverage and outbound HO triggering be triggered while having increased measurement activity and will therefore not be delayed. So if UE is moving fast then it helps.

If on the other hand, the UE is not moving then the impact from performing additional measurements is limited due to the limited time when applying the additional measurements. So the impact on non-moving/slow moving UE is very limited and if measurements are kept independent from PDCCH monitoring rule (DRX) the power consumption impact can be further reduced to become very limited.

There is a need to have this behavior defined and specified in a manner that can ensure some minimum UE performance. It is not very beneficial to have a non-specified solution for this behavior as it does not ensure any guarantee when it becomes UE behavior in the field (and if supported by all UEs). Well defined behavior among the UEs in the field is essential for network planning and for enabling optimal configuration of network and UEs.

In addition to above behavior it is likely necessary also to include a UE back off timer which limits the time period during which additional measurements will be performed. Where there is small cell coverage, for example, UE can calculate its own maximum time period, or the maximum time period can be configured for the UE, such as by the network. UE will use this maximum time period and implement some limiting options on UE side, for limiting UE power consumption impact.

The increased measurement activity is not followed by a PDCCH monitoring requirement (feature can work independent from DRX). UE will only be required to perform measurement and there would not (necessarily) be a requirement for the UE to monitor the PDCCH as well. This will ensure absolute minimum UE impact concerning power consumption from this feature. Additionally it would enable UE implementation freedom when it comes to the detailed measurement implementation (can be optimized for different vendors as it suits their algorithms). Also it would enable that the feature impact can be minimized on UE side in case of misconfiguration from network side. By not linking the additional measurement requirement to PDCCH monitoring rule (DRX) the risk of losing synchronization between a UE and network is also prevented.

Further, in accordance with the exemplary embodiments, functionality with the existing long and short DRX behavior can be combined. This is not as optimized from a UE power consumption point of view as it would then most likely also require the UE to monitor the PDCCH according to DRX rules. In accordance with another exemplary embodiment, a UE could apply short DRX for an extended period of time after an inbound HO to all cells or certain cell types. UE measurement points could then be defined according to prior art with short and long DRX.

It is note that the operations described herein, such as operations performed during an RRC connected mode, as an example, are none limiting. The exemplary embodiments of the can also be used to benefit idle mode mobility, such as RRC_idle mode mobility.

FIGS. 3 and 4 each illustrate simulation results of mobility performance with regards to percentages of failed pico and macro handovers. In FIG. 3 the results are based on a long DRX of 2560 ms, whereas the results of FIG. 4 are based on a short DRX of 640 ms.

In FIGS. 3 and 4, the measurements are based on a mobile device (e.g., UE) moving about 30 kilometers per hour. FIG. 4 is based on after HO to small cell UE measurement interval is 160 ms for 5, 10 or 15 second period. The UE moves (speed 30 kmph) about 40, 80 or 120 meters during the increased measurement period.

In the simulations, ‘IMtime0’ illustrates the baseline results (as defined by present day 3GPP standards without changes) while IMtime5, 10 and 15 indicates the results from applying increased/additional measurements according to the method, in accordance with the embodiments, for 5, 10 and 15 seconds after inbound HO to the cell.

With regards to FIG. 3, it can be seen that UE is applying a long DRX is moving at 30 km/h, for example, the impact of a small HO region becomes significant especially as a velocity of the UE increases.

However, with regards to FIG. 4, in accordance with the exemplary embodiments, the UE is applying a short DRX. In this scenario, the short DRX will enable the UE to perform measurements more frequently, or the whole time, while connected to a pico cell. As can be seen in FIG. 4 the method in accordance with the exemplary embodiments provides over a 50% drop in handover failures versus the prior art.

As can be seen from FIG. 4 there are only minor mobility problems when looking at DRX of 640 ms at 3 km/h. In FIG. 4, at or near the 3 km/h velocity (4 leftmost bars in the figure) HO failure rate is already very small in IMtime0 (the leftmost bar) case. So at different velocities around this relatively slow speed there is little impact and any increased measurements are not so significant. However, as can be seen in FIGS. 3 and 4 at or around the 30 kmph mark velocity, for example, the gain of the method, as in accordance with the exemplary embodiments, is significant. Thus, the HO failure rate is significantly lowered after application of a method, in accordance with the exemplary embodiments. Further, it is noted that the 640 ms DRX is non-limiting. The DRX, in accordance with the exemplary embodiments, can be set to any length below or above 640 ms.

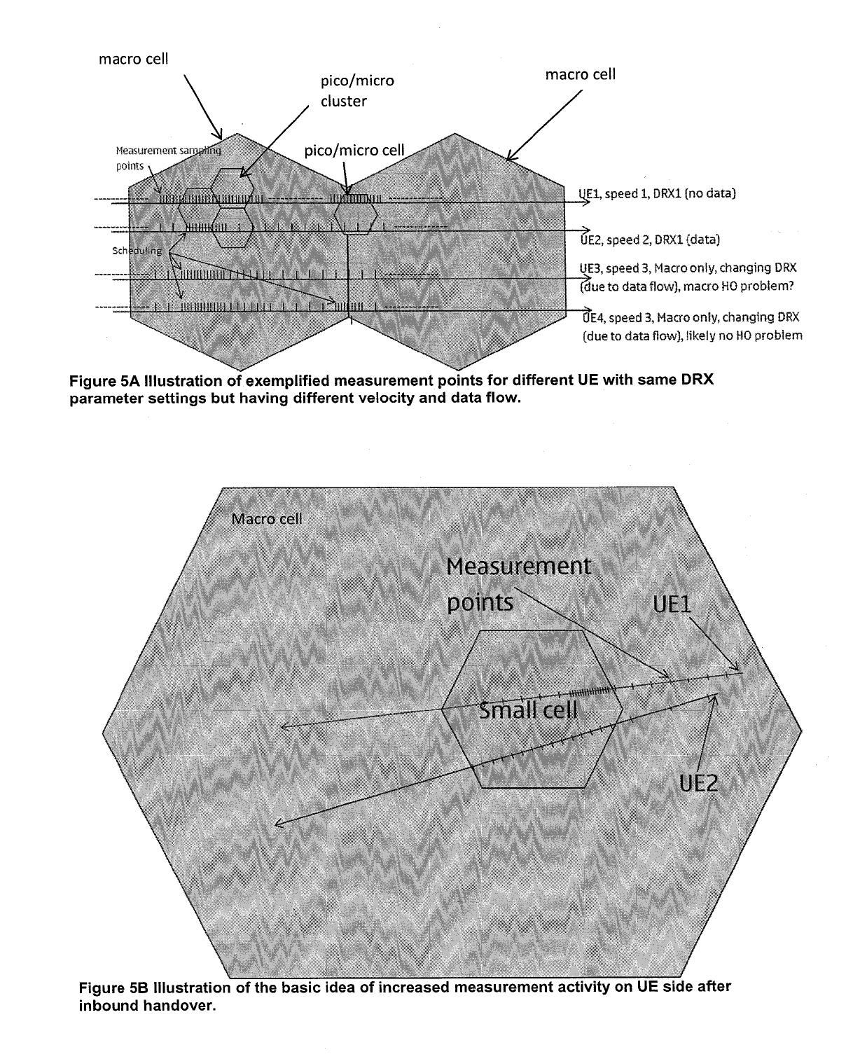

With regards to FIG. 5A, there is shown a set of UEs 1, 2, 3 and 4 with the same basic DRX settings. The different UEs having different data flows are moving at different velocities. In accordance with the exemplary embodiments of the invention, the UEs measurement points can be scaled differently at different points.

In FIG. 5B it can be seen that both UEs will apply increased measurement activity immediately after inbound handover to the small cell. In this example the UE1 is moving at low speed (e.g. pedestrian) while UE2 is moving at higher speed (e.g. 60 km/h). Even though the UE prior to inbound had a given (maybe not even same) DRX configuration each UE will after the inbound handover apply the increased measurements for a given period of time (note: does not have to be linked to DRX).

For a slow moving UE (here UE1) this will lead to increased measurements for a limited time period. Although the measurements are quite unnecessary in this case they do not have any severe negative impact on the UE (only performed for a limited time). Here it can be seen that due to slow velocity of the UE it will not travel far during the time taking the additional measurements, but instead the measurement points will be very close in terms in traveled distance.

For the faster moving UE (here UE2) it will also apply increased measurement activity for a time period after HO. In this case the increased measurement availability has positive impact on the robustness of the UE mobility. Reason is that the UE will perform the additional measurement also only for a limited time period, but due to the UE velocity it basically leads to UE performing additional measurements while being in the small cell coverage and thereby there will not be an additional delay in outbound handover triggering. Further, after a HO the measurement interval applied for both UE1 and UE2, is the same.

With regards to FIG. 5B, it can be seen that both UEs will apply increased measurement activity immediately after inbound handover to the small cell. In this example the UE1 is moving at low speed (e.g. pedestrian) while UE2 is moving at higher speed (e.g. 60 km/h). Even though the UE prior to inbound had a given (maybe not the same) DRX configuration each UE will after the inbound handover apply the increased measurements for a given period of time (note: does not have to be linked to DRX).

For a slow moving UE (here UE1) this will lead to increased measurements for a limited time period. Although the measurements are quite unnecessary in this case they do not have any severe negative impact on the UE (only performed for a limited time). From FIG. 5B it can be seen that due to slow velocity of the UE it will not travel far during the time taking the additional measurements, but instead the measurement points will be very close in terms in traveled distance.

For the faster moving UE (here UE2) it will also apply increased measurement activity for a time period after HO. In this case the increased measurement availability has positive impact on the robustness of the UE mobility. A reason for this is that the UE will perform the additional measurement also only for a limited time period, but due to the UE velocity it basically leads to UE performing additional measurements while being in the small cell coverage and thereby there will not be an additional delay in outbound handover triggering. Further, with regards to FIG. 5B, after a HO the measurement interval applied for both UE1 and UE2, is the same.

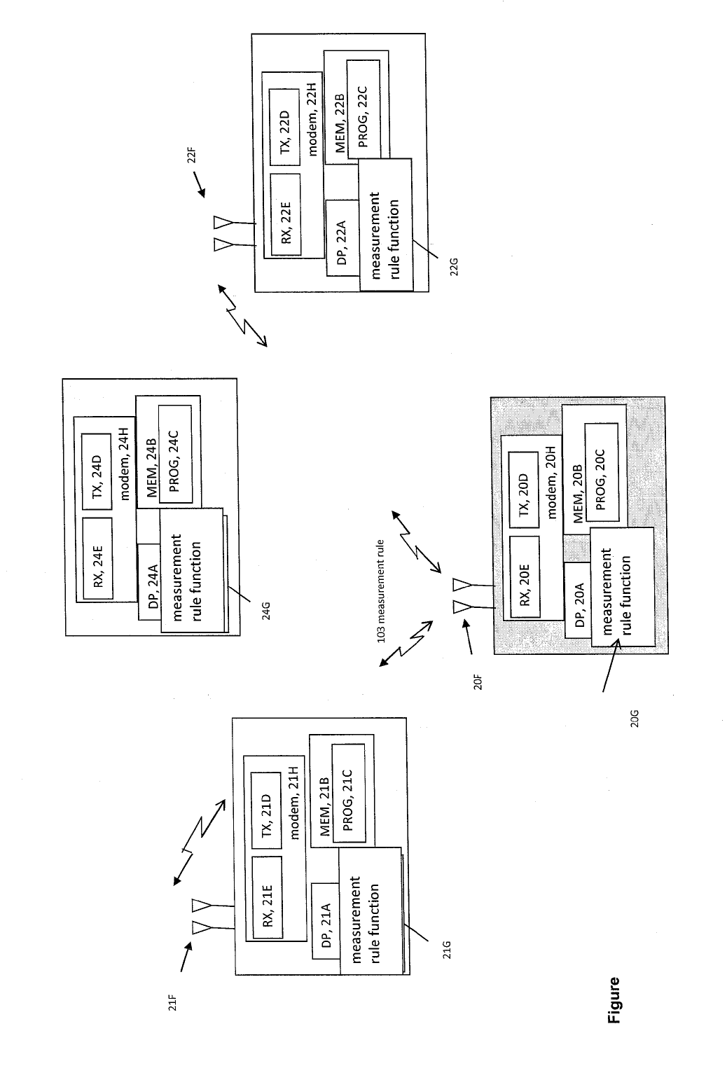

A reference is now made to FIG. 6 for illustrating a simplified block diagram of various electronic devices and apparatus that are suitable for use in practicing the exemplary embodiments of this invention. In FIG. 6 a network node 20 is adapted for communication over a wireless link (not specifically shown) with mobile apparatuses, such as mobile terminals, UEs or user devices 21, 22 and 24. The network node 20 can be a WLAN access point or any WiFi device enabled to operate in accordance with the exemplary embodiments of the invention as described above. The UEs or user devices 21, 22 and 24 can be any device in the wireless network 1 enabled to operate in accordance with the exemplary embodiments of the invention as described above. The network node 20 may be embodied in a network node of a communication network, such as embodied in a base station of a cellular network or another device of the cellular network. In one particular implementation, any of the user devices 21, 22 and 24 may be embodied as a WLAN station STA, either an access point station or a non-access point station, or may be incorporated in a cellular communication device.

The network node 20 includes processing means such as at least one data processor (DP) 20A, storing means such as at least one computer-readable memory (MEM) 20B storing at least one computer program (PROG) 20C, and may also comprise communicating means such as a transmitter TX 20D and a receiver RX 20E for bidirectional wireless communications with the user device 24 via one or more antennas 20F. The RX 20E and the TX 20D are each shown as being embodied with a modem 20H in a radio-frequency front end chip, which is one non-limiting embodiment; the modem 20H may be a physically separate but electrically coupled component. Further, the network node 20 incorporates a measurement rule function 20G which is coupled to at least the DP 20A, the MEM 20B and the PROG 20C of the network node 20. The PP-MAC function 20G to be used with at least the MEM 20B and DP 20A to perform the operations in accordance with the exemplary embodiments of the invention including, but not limited to, determining and processing the measurement configuration 103 in order to cause the user devices 21, 22, and 24 to implement different DRX cycle operations, perform measurements, determine MSE, and mobility status.

The user device 21 similarly includes processing means such as at least one data processor (DP) 21A, storing means such as at least one computer-readable memory (MEM) 21B storing at least one computer program (PROG) 21C, and may also comprise communicating means such as a transmitter TX 21D and a receiver RX 21E and a modem 21H for bidirectional wireless communications with other apparatus of FIG. 6 via one or more antennas 21F. Using a measurement rule function 21G, the user device 21 is at least enabled to perform the operations in accordance with the exemplary embodiments of the invention including, but not limited to processing the measurement configuration 103 from the network node 20, implementing different DRX cycle operations, performing measurements, determining MSE, and mobility status, as described above.

Similarly, the user device 22 includes processing means such as at least one data processor (DP) 22A, storing means such as at least one computer-readable memory (MEM) 22B storing at least one computer program (PROG) 22C, and may also comprise communicating means such as a modem 22H for bidirectional communication with the other devices. Similar to the user device 21 the user device 22 is at least enabled, using the measurement rule function 22G to perform the operations in accordance with the exemplary embodiments of the invention including, but not limited to, processing the measurement configuration 103 from the network node 20, implementing different DRX cycle operations, performing measurements, determining MSE, and mobility status.

The user device 24 includes its own processing means such as at least one data processor (DP) 24A, storing means such as at least one computer-readable memory (MEM) 24B storing at least one computer program (PROG) 24C, and may also comprise communicating means such as a transmitter TX 24D and a receiver RX 24E and a modem 24H for bidirectional wireless communications with devices 20, 21, 22 and 24 as detailed above via its antennas 24F. Thus, similar to the user devices 21 and 22 the user device 24 is at least enabled, using the measurement rule function 24G, to perform the operations in accordance with the exemplary embodiments of the invention including, but not limited to processing the measurement configuration 103 from the network node 20, implementing different DRX cycle operations, performing measurements, determining MSE, and mobility status. In addition, while the network node 20 and user devices 21, 22 and 24 are discussed with respect to the network node 20 acting as a centralized node, the disclosure included herein may also apply to different networks, such as a pico and/or mesh network in which any node may include a measurement rule function to other nodes and send or receive measurement configuration from the other nodes, as can the network node 20.

At least one of the PROGs 20C, 21C, 22C and 24C in the respective network device 20, 21, 22 and 24 is assumed to include program instructions that, when executed by the associated DP 20A, 21A, 22A and 24A enable the respective device to operate in accordance with the exemplary embodiments of this invention, as detailed above. Blocks 20G, 21G, 22G and 24G summarize different results from executing different tangibly stored software to implement certain aspects of these teachings. In these regards the exemplary embodiments of this invention may be implemented at least in part by computer software stored on the MEM 20B, 21B, 22B and 24B which is executable by the DP 20A, 21A, 22A and 24A of the respective other devices 20, 21, 22 and 24 or by hardware, or by a combination of tangibly stored software and hardware (and tangibly stored firmware). Electronic devices implementing these aspects of the invention need not be the entire devices as depicted at FIG. 6, but exemplary embodiments may be implemented by one or more components of same such as the above described tangibly stored software, hardware, firmware and DP, or a system on a chip SOC or an application specific integrated circuit ASIC.

Various embodiments of the computer readable MEMs 20B, 21B, 22B and 24B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 21A, 22A and 24A include but are not limited to general purpose computers, special purpose computers, microprocessors, digital signal processors (DSPs) and multi-core processors.

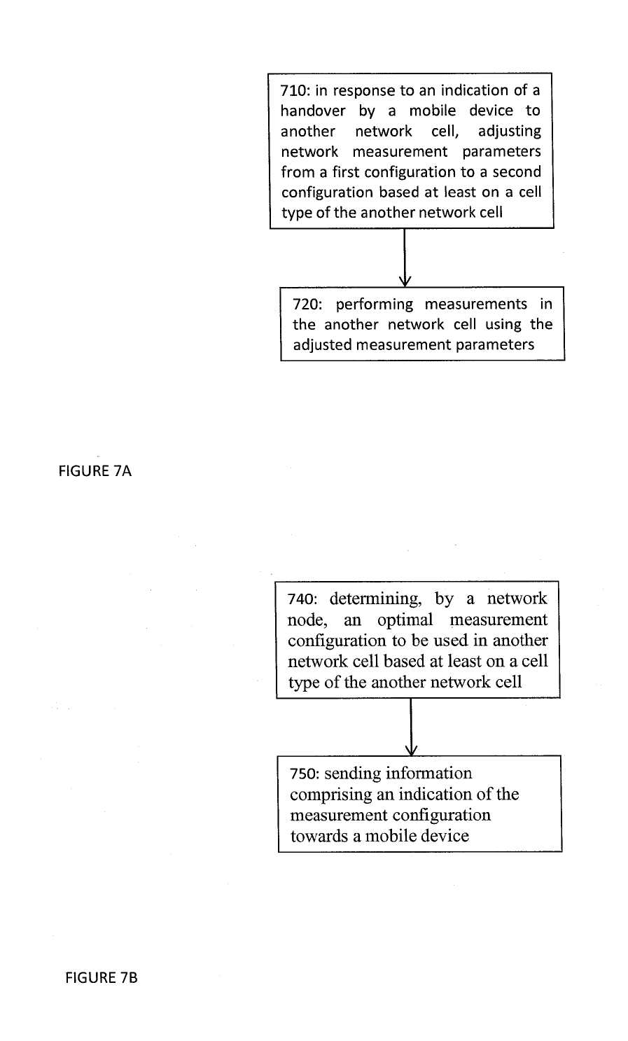

FIGS. 7A and 7B include block diagrams illustrating a method which may be implemented by at least an apparatus in accordance with the exemplary embodiments of the invention.

With regards to FIG. 7A, in block 710 there is, in response to an indication of a handover by a mobile device to another network cell, adjusting network measurement parameters from a first configuration to a second configuration based at least on a cell type of the another network cell. At block 720, there is performing measurements in the another network cell using the adjusted measurement parameters.

The exemplary embodiments of the invention as described in the paragraph above, the adjusting the network measurement parameters comprises at least one of decreasing an interval between measurements and scaling down a length of a discontinuous reception cycle to increase an amount of the measurements over a period of time.

The exemplary embodiments of the invention as described in the paragraphs above, the adjusting is based on at least one of an estimated mobility state of the mobile device, and a cell type of the another network cell.

The exemplary embodiments of the invention as described in the paragraphs above, where the mobility state is estimated to be above normal, and where the estimated mobility state is based on at least one of a profile of the mobile device and the above normal mobility state.

The exemplary embodiments of the invention as described in the paragraph above, where the cell type is based on at least one of a cell size, a cell weighting factor, and a priority status of the another network cell.

The exemplary embodiments of the invention as described in the paragraphs above, further comprising determining that the mobility state is no longer above normal; and based on the determining, re-adjusting the network measurement parameters to return to the first configuration.

The exemplary embodiments of the invention as described in the paragraphs above, further comprising, in response to the indication of the handover, receiving information from a network node, where the information comprises at least one field indicating a scaling factor to shorten a discontinuous reception cycle at the mobile device.

The exemplary embodiments of the invention as described in the paragraphs above, where the information is received via S1/X2 information elements.

The exemplary embodiments of the invention as described in the paragraphs above, where the information comprises at least one field to indicate a time period to perform the measurements, and where the time period to perform the measurements is based on a mobility state of the mobile device.

At least one computer-readable memory embodying at least one computer program code, the at least one computer program code executed by at least one data processor to perform the method according to the paragraphs above.

Further, in accordance with the exemplary embodiments of the invention, there is an apparatus comprising means, in response to an indication of a handover by a mobile device to another network cell, for adjusting network measurement parameters from a first configuration to a second configuration based at least on a cell type of the another network cell, and means for performing measurements in the another network cell using the adjusted measurement parameters.

The exemplary embodiments of the invention as described in the paragraph above, the means for adjusting the network measurement parameters comprises at least one of decreasing an interval between measurements and scaling down a length of a discontinuous reception cycle to increase an amount of the measurements over a period of time.

The exemplary embodiments of the invention as described in the paragraphs above, the means for adjusting is based on at least one of an estimated mobility state of the mobile device, and a cell type of the another network cell.

The exemplary embodiments of the invention as described in the paragraphs above, where the mobility state is estimated to be above normal, and where the estimated mobility state is based on at least one of a profile of the mobile device and the above normal mobility state.

The exemplary embodiments of the invention as described in the paragraph above, where the cell type is based on at least one of a cell size, a cell weighting factor, and a priority status of the another network cell.

The exemplary embodiments of the invention as described in the paragraphs above, further comprising means for determining that the mobility state is no longer above normal; and based on the determining, and means for re-adjusting the network measurement parameters to return to the first configuration.

The exemplary embodiments of the invention as described in the paragraphs above, further comprising, means, in response to the indication of the handover, for receiving information from a network node, where the information comprises at least one field indicating a scaling factor to shorten a discontinuous reception cycle at the mobile device.

The exemplary embodiments of the invention as described in the paragraphs above, where the information is received via S1/X2 information elements.

The exemplary embodiments of the invention as described in the paragraphs above, where the information comprises at least one field to indicate a time period to perform the measurements, and where the time period to perform the measurements is based on a mobility state of the mobile device.

The exemplary embodiments of the invention as described in the paragraphs above, where the means for adjusting and the means for performing comprises an interface to a wireless communication network; and at least one memory embodying computer program code, the at least one computer program code executed by at least one processor.

With regards to FIG. 7B, in block 740 there is determining, by a network node, an optimal measurement configuration to be used in another network cell based at least on a cell type of the another network cell. In block 750 there is sending information comprising an indication of the measurement configuration towards a mobile device.

The exemplary embodiments of the invention as described in the paragraphs above, where the determining is further based on at a mobility state of the mobile device.

The exemplary embodiments of the invention as described in the paragraphs above, where the information comprises at least one field to indicate a time period to perform the measurements, and where the time period to perform the measurements is based on a mobility state of the mobile device.

The exemplary embodiments of the invention as described in the paragraphs above, where the information comprises at least one field to indicate a scaling factor to shorten a discontinuous reception cycle to increase an amount of measurements over a period of time at the mobile device.

The exemplary embodiments of the invention as described in the paragraphs above, where the information is sent using S1/X2 information elements.

The exemplary embodiments of the invention as described in the paragraphs above, where the information is sent in a broadcast message.

The exemplary embodiments of the invention as described in the paragraphs above, where the sending the information is in response to one of the mobile station being in close proximately of the another network cell and the mobile station being handover to the another network cell.

Further, in accordance with the exemplary embodiments of the invention, there is an apparatus comprising means for means for determining, with a network node, an optimal measurement configuration to be used in another network cell based at least on a cell type of the another network cell, and means for sending information comprising an indication of the measurement configuration towards a mobile device.

The exemplary embodiments of the invention as described in the paragraphs above, where the means for determining is further based on at a mobility state of the mobile device.

The exemplary embodiments of the invention as described in the paragraphs above, where the information comprises at least one field to indicate a time period to perform the measurements, and where the time period to perform the measurements is based on a mobility state of the mobile device.

The exemplary embodiments of the invention as described in the paragraphs above, where the information comprises at least one field to indicate a scaling factor to shorten a discontinuous reception cycle to increase an amount of measurements over a period of time at the mobile device.

The exemplary embodiments of the invention as described in the paragraphs above, where the information is sent using S1/X2 information elements.

The exemplary embodiments of the invention as described in the paragraphs above, where the information is sent in a broadcast message.

The exemplary embodiments of the invention as described in the paragraphs above, where the sending the information is in response to one of the mobile station being in close proximately of the another network cell and the mobile station being handover to the another network cell.

The exemplary embodiment of the invention as described in the paragraphs above, where the means for determining and the means for sending comprises an interface to a wireless communication network, and at least one memory embodying computer program code, the at least one computer program code executed by at least one processor.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Further, it should be noted that the term “normal,” or any variant thereof, can mean common or original or generally acceptable. The term normal is used in conjunction with at least movement speed and MSE and a mobility state of a network device, such as a UE. Further, the term velocity can mean speed of movement and/or direction of movement by a network device, such as a UE. Further, mobility state of a UE can be also defined, but not limited to, as “normal”, “medium” or “high” according to 3GPP Release 8 definition of Mobility State Estimation specified in TS 36.304 and TS 36.331. Further, a mobility status of a UE could be based on the detected mobility events, or similar metric derived from measurements of signals from the cells being discovered, rather than just executed mobility events. Mobility state estimation could also be based on any other advanced method which can be used for estimating UE mobility like e.g. GPS, advanced measurements and alike.

Furthermore, some of the features of the preferred embodiments of this invention could be used to advantage without the corresponding use of other features. As such, the foregoing description should be considered as merely illustrative of the principles of the invention, and not in limitation thereof.

1-38. (canceled)

39. A method comprising:
in response to an indication of a handover by a mobile device to another network cell, adjusting network measurement parameters from a first configuration to a second configuration based at least on a cell type of the another network cell; and
performing measurements in the another network cell using the adjusted measurement parameters.

40. The method according to claim 39, where the adjusting the network measurement parameters comprises at least one of decreasing an interval between measurements and scaling down a length of a discontinuous reception cycle to increase an amount of the measurements over a period of time.

41. The method according to claim 39, where the adjusting is based on an estimated mobility state of the mobile device.

42. The method according to claim 41, where the mobility state is estimated to be above normal, and where the estimated mobility state is based on at least one of a profile of the mobile device and the above normal mobility state.

43. The method according to claim 39, where the cell type is based on at least one of a cell size, a cell weighting factor, and a priority status of the another network cell.

44. The method according to claim 39, further comprising, in response to the indication of the handover, receiving information from a network node, where the information comprises at least one field indicating a scaling factor to shorten a discontinuous reception cycle at the mobile device.

45. The method according to claim 44, where the information is received via S1/X2 information elements.

46. The method according to claim 44, where the information comprises at least one field to indicate a time period to perform the measurements, and where the time period to perform the measurements is based on a mobility state of the mobile device.

47. The method according to claim 39, where the sending the information is in response to one of the mobile device being in close proximately of the another network cell and the mobile device being handover to the another network cell.

48. At least one computer-readable memory embodying at least one computer program code, the at least one computer program code executed by at least one data processor to perform the method according to claim 39.

49. An apparatus comprising:
at least one processor; and
at least one memory including computer program code, where the at least one memory and the computer program code are configured, with the at least one processor, to cause the apparatus to at least:
in response to an indication of a handover by a mobile device to another network cell, adjust network measurement parameters from a first configuration to a second configuration based at least on a cell type of the another network cell; and
perform measurements in the another network cell using the adjusted measurement parameters.

50. The apparatus according to claim 49, where the adjusting the network measurement parameters comprises the at least one memory including the computer program code is configured, with the at least one processor, to cause the apparatus to at least one of decrease an interval between measurements and scale down a length of a discontinuous reception cycle to increase an amount of the measurements over a period of time.

51. The apparatus according to claim 49, where the adjusting is based on at least one of an estimated mobility state of the mobile device, and a cell type of the another network cell.

52. A method comprising:
determining, by a network node, an optimal measurement configuration to be used in another network cell based at least on a cell type of the another network cell; and
sending information comprising an indication of the measurement configuration towards a mobile device.

53. The method according to claim 52, where the determining is further based on at a mobility state of the mobile device.

54. The method according to claim 52, where the information comprises at least one field to indicate a time period to perform the measurements, and where the time period to perform the measurements is based on a mobility state of the mobile device.

55. The method according to claim 52, where the information comprises at least one field to indicate a scaling factor to shorten a discontinuous reception cycle to increase an amount of measurements over a period of time at the mobile device.

56. The method according to claim 52, where the information is sent using S1/X2 information elements.

57. The method according to claim 52, where the information is sent in a broadcast message.

58. At least one computer-readable memory embodying at least one computer program code, the at least one computer program code executed by at least one data processor to perform the method according to claim 52.
